(19) United States
(12) Patent Application Publication
(10) Pub. No.: US 2009/0006743 A1
(43) Pub. Date: Jan. 1, 2009

(54) Writing data to multiple storage devices

(76) Inventor: Chee Keong Sim, Selangor (MY)

Correspondence Address: TROP PRUNER & HU, PC, 1616 S. VOSS ROAD, SUITE 750, HOUSTON, TX, 77057-2631, US

(21) Appl. No.: 11/823,399

(22) Filed: Jun. 27, 2007

(51) Int. Cl. G06F 12/00

(52) U.S. Cl. 711/114; 711/E12.001

(57) ABSTRACT

In one embodiment, the present invention includes a method to write a first block group of multiple data blocks of a write request into a first disk in a first time period, and write a second block group of the multiple data blocks into the second disk in the first time period. Later a flip write process may be performed to write the first and second block groups into the other disk. Other embodiments are described and claimed.

### BACKGROUND

Redundant array of inexpensive or independent disks (“RAID”) devices are an increasingly popular way to store large amounts of data. RAID devices typically include a RAID controller and multiple low capacity personal computer type disk drives that are bundled together to form a single high capacity drive. A RAID device is usually less expensive than conventional high capacity drives because the personal computer type drives are relatively inexpensive based on their high volume of production.

Because RAID devices include multiple disk drives, the probability that one of the drives will fail at any given time is relatively high. An issue with RAID devices is how to avoid the loss of data when one or more of the drives fail. One solution to this issue is to mirror a single data block across multiple disk drives in the RAID device. The data block is mirrored by writing the block into at least two disk drives.

A so-called RAID 1 implementation is basically based on a mirroring concept where two disks include identical data (a similar write operation is simultaneously performed to both disks). The use of RAID 1 is for its data reliability and fault tolerance. While this configuration enables fast reading because the system can get two chunks of data from each disk separately in parallel, there is no advantage at the write operation because the two chunks of data will have to be written in sequence to both disks.

### BRIEF DESCRIPTION OF THE DRAWINGS

FIG. 1 is a flow diagram of a method in accordance with one embodiment of the present invention.

FIG. 2 is a block diagram of a plurality of storage devices in accordance with one embodiment of the present invention.

FIG. 3 is a timing diagram of operations in accordance with an embodiment of the present invention.

FIG. 4 is a block diagram of a computer system which may be used with embodiments of the present invention.

### DETAILED DESCRIPTION

In various embodiments, in a system implementing a RAID configuration, for example, a RAID 1 configuration in which disk mirroring is performed to simultaneously write data to each of a pair of disks, a fast writing option may be provided. More specifically, write operations may be performed at approximately twice the speed of conventional RAID 1 write operations. Such speeds may be realized, as embodiments may simultaneously write different data chunks to each of the RAID drives, enabling all of a data transfer to be performed in half the time of a conventional RAID write operation. Then at a later time, a so-called flip write operation may be performed in which the data written to the first drive is written to the second drive and vice-versa.

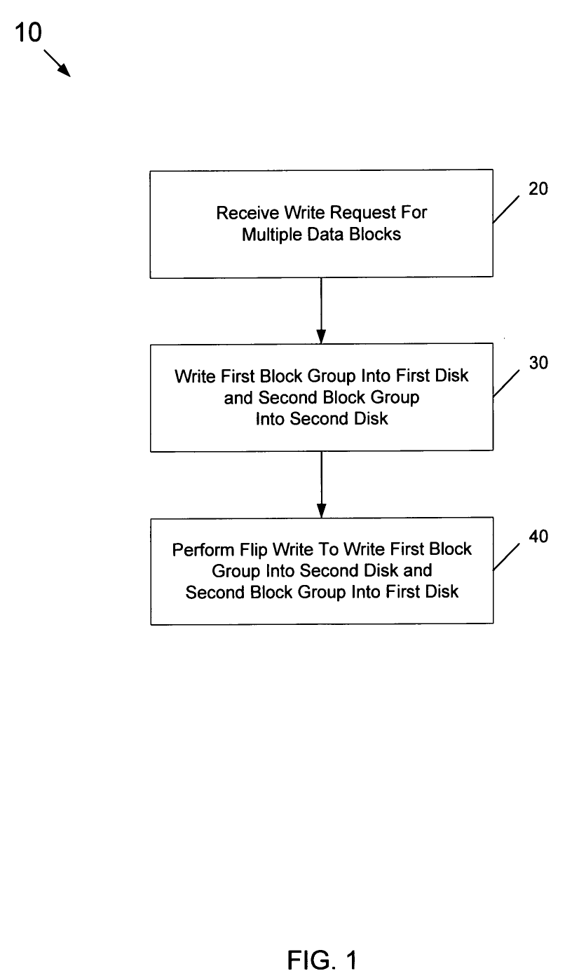

Referring now to FIG. 1, shown is a flow diagram of a method in accordance with one embodiment of the present invention. As shown in FIG. 1, method 10 may be used to perform fast write operations in a RAID system. Method 10 may begin by receiving a write request for multiple data blocks (block 20). Such a write request may be received from a processor or other initiator. The request may be received in a disk drive controller such as a RAID controller, e.g., present in an input/output (IO) controller hub (ICH), a host controller interface such as an advanced host controller interface (AHCI) or another such controller associated with multiple disk drives, e.g., two drives of a RAID system present in a personal computer (PC) or other such computer system.

Referring still to FIG. 1, responsive to this write request a first block group may be written into the first disk, while a second block group may be written into the second disk (block 30). In one embodiment, the first block group may correspond to even data blocks and the second block group to odd data blocks. Even and odd data blocks may be based on a most significant bit, least significant bit, or other such basis. Similarly, the first disk drive may correspond to an even disk drive and the second disk drive to an odd disk drive. Accordingly, the write may proceed in half the amount of time that would be required to write all of the data blocks to both drives simultaneously.

Referring still to FIG. 1, at a later time, e.g., when a utilization rate of the drives is at a lower level such as below a predetermined threshold level, when the drives are idle, or at another selected time, the operation at block 40 may be performed. More specifically, a flip write operation may be performed to write the first block group into the second disk and the second block group into the first disk. That is, a flip write operation is primarily a copy operation in which non-mirrored data from the first drive is written into the second drive, and vice versa. While shown with this particular implementation in the embodiment of FIG. 1, the scope of the present invention is not limited in this regard and other embodiments may be possible. Furthermore, while shown in the embodiment of FIG. 1 as being associated with two disk drives, embodiments may be implemented in RAID configurations including multiple disks such as four, eight or more such disks.

Thus using embodiments, a user may choose to have improved write speeds to provide a better user experience, while maintaining fault tolerance of a RAID system after a flip write operation is performed. Note that the user selectability of the fast RAID write operation may be enabled at a disk level, a folder level, an application level and so forth. For example, a user may select to enable the fast write operations for certain applications such as content creation of multimedia content, while not enable it for other applications. Furthermore, while described as a RAID 1 variant, embodiments may be applicable to other RAID configurations.

In various embodiments a queue or journal keeps track of the not yet mirrored write processes. The queue may be present in a controller such as a RAID controller. The mirroring work may be enabled as indicated in the queue when disk activity is low or before system restart/shutdown. In some embodiments, in the event of power disruption, a utility can check through the disks for differences in terms of error correction coding (ECC) and perform read and flip writes to obtain mirrored drives.

Accordingly in some embodiments, writes are completed earlier, although a longer time may be needed to mirror. Under normal desktop usage model, there will be rarely 100% hard disk access throughout the usage. Take software installation for example, a user installs a program, and tests it after installation completes. The user will be able to complete the installation faster, and test it. At the moment of testing, the mirroring can happen. Another example may be photo or movie editing. After edits, a user saves it, and proceeds to edit another photo or movie. The user can proceed to the next edit faster due to fast write, and during the user edit effort, the hard disk usage might be low and thus mirroring can happen.

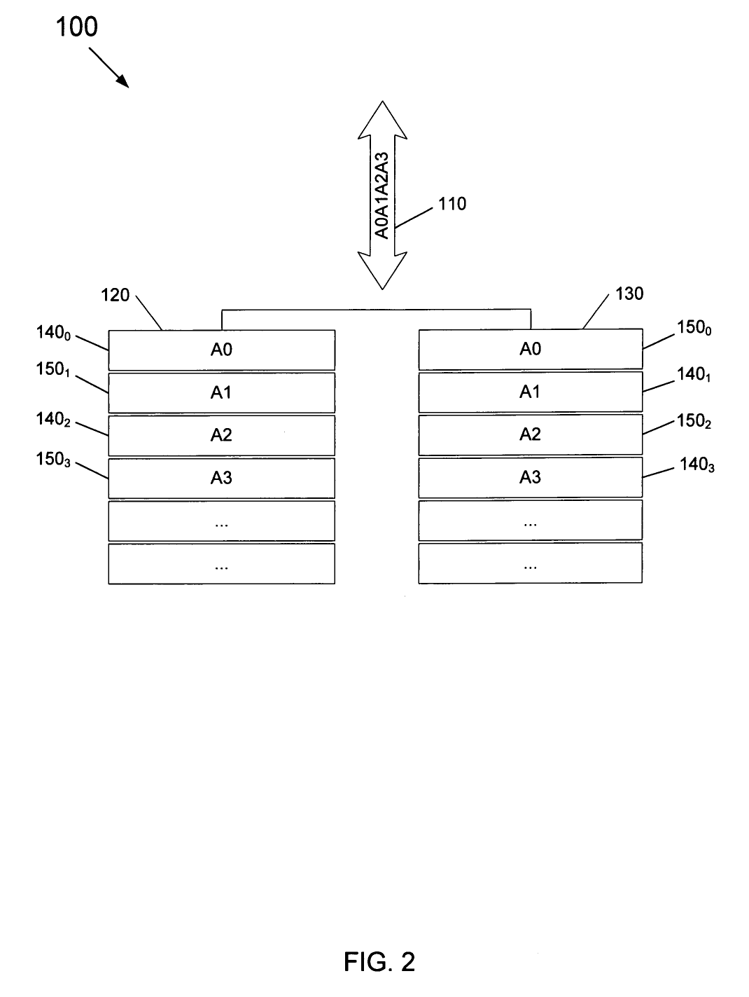

Thus as shown in FIG. 2, a RAID system 100 includes a first disk 120 and a second disk 130, which may correspond to an even disk and an odd disk, respectively. As shown in FIG. 2, an incoming write request 110 may seek to write four data blocks, namely data blocks A0-A3. To enable a fast write operation in accordance with an embodiment of the present invention, a fast write operation may be performed to write respective even data blocks into even drive 120 and odd data blocks into odd drive 130. Thus as shown in FIG. 2, during a fast write operation, data blocks 140₀-140₃ are written into the respective drives 120 and 130. More specifically, blocks A0 and A2 will be written into first disk 120, while blocks A1 and A3 are written to second disk 130. To make sure a user can read back the correct data, a read process may follow the similar sequence. With the stripe-like writing, a user can complete the write process at the faster speed (i.e., finish installation earlier and use it, finish video rendering earlier, etc). Then at a later time, namely corresponding to a flip write operation, data blocks 150₀-150₃ are written into first and second drives 120 and 130, respectively. More specifically data blocks A1 and A3 are written to first disk 120 and blocks A0 and A2 to second disk 130.

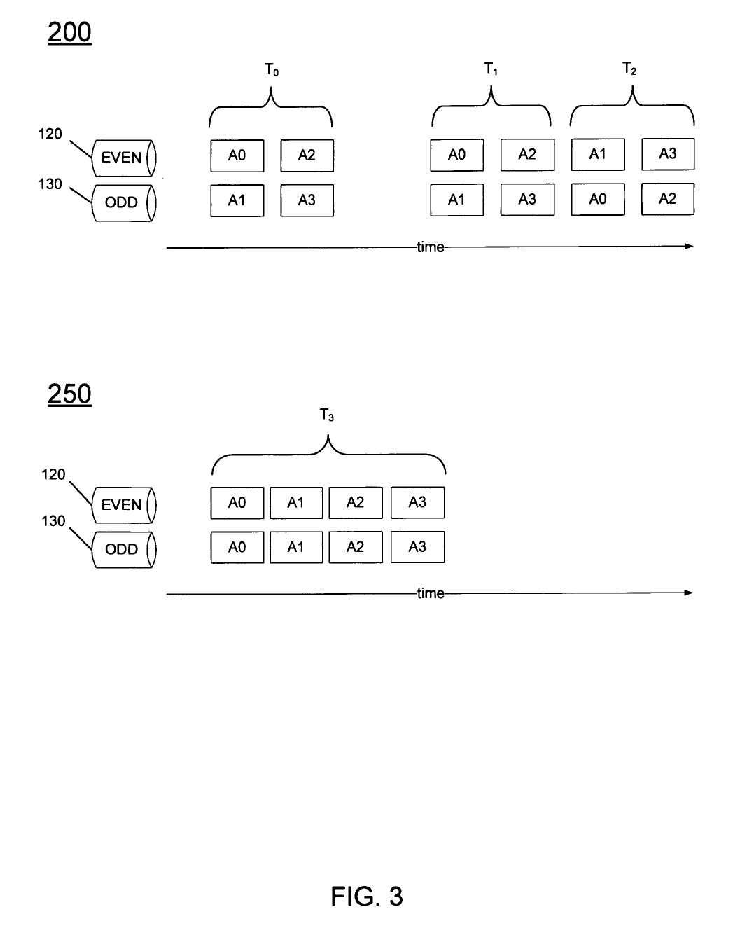

As shown in FIG. 3, which is a timing diagram of operations in accordance with an embodiment of the present invention, at a time T0, four data blocks may be written into first and second drives 120 and 130, namely two data blocks in each drive. Then at a later time T1, the data blocks may be read out of the drives. Still further, at a later time T3, a flip write operation may be performed to write the data blocks in a mirrored fashion to first and second drives 120 and 130. Thus as shown in timing diagram 200, all data may be written to disk in a first time period T0, enabling fast write operations. In contrast, as shown in timing diagram 250 during a conventional RAID write operation, all four data blocks are written simultaneously or at least substantially simultaneously to first and second disks 120 and 130, consuming a time period T3, which may be twice the time required for time period T0.

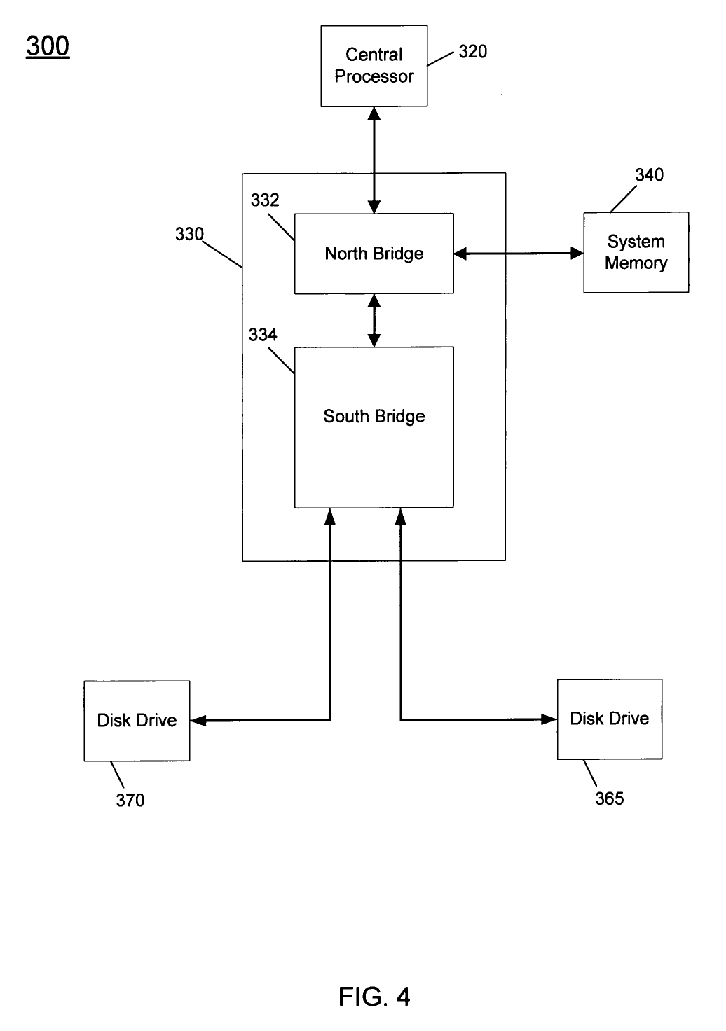

FIG. 4 is a block diagram of a computer system which may be used with embodiments of the present invention. The computer system 300 includes a central processor 320 that is coupled to a chipset 330, which in turn is coupled to a system memory 340. In one embodiment, a system memory controller is located within a north bridge 332 of chipset 330. In another embodiment, a system memory controller is located on the same chip as central processor 320. Information, instructions, and other data may be stored in system memory 340 for use by central processor 320 as well as many other potential devices.

Disk drives 365 and 370 which may be even and odd RAID drives of a RAID 1 system, are coupled to a south bridge 334 of chipset 330 through one or more I/O interconnects. In this embodiment, a host controller may be located within south bridge 334 of the chipset 330 to allow drives 365 and 370 to communicate with the rest of the computer system. The host controller may be in accordance with the serial advanced technology attachment (SATA), Advanced Host Controller Interface (AHCI) rev. 1.1 or another such specification, and may further include a RAID controller to enable fast RAID writes in accordance with an embodiment of the present invention, which may be performed responsive to user control such as a user-controlled setting or a user level instruction.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a write request to write multiple data blocks into a redundant array of inexpensive or independent disks (RAID) system including a first disk and a second disk; and
writing a first block group of the multiple data blocks into the first disk in a first time period, and writing a second block group of the multiple data blocks into the second disk in the first time period, wherein the first block group and the second block group are different groups of data and at the conclusion of the first time period the first disk and the second disk are non-mirrored.

2. The method of claim 1, further comprising performing a second write operation to write the first block group into the second disk and write the second block group into the first disk, during a second time period, the second time period after the first time period, wherein the first disk and the second disk are mirrored at the conclusion of the second time period.

3. The method of claim 2, further comprising initiating the second write operation when an activity level of the first disk and second disk is below a threshold.

4. The method of claim 2, further comprising initiating the second write operation after a power disruption event.

5. The method of claim 1, further comprising receiving the write request in RAID controller.

6. The method of claim 1, wherein the first block group corresponds to even data blocks and the second block group corresponds to odd data blocks.

7. The method of claim 1, further comprising receiving a user command to enable the writing of the first block group into the first disk and the second block group into the second disk during the first time period.

8. The method of claim 7, further comprising otherwise writing the first block group and the second block group into both of the first disk and the second disk during a second time period, wherein the second time period includes the first time period and an additional time period.

9. The method of claim 7, further comprising receiving the user command on a per application granularity.

10. The method of claim 2, further comprising performing the second write operation based on entries in a queue, wherein the queue is to store entries each corresponding to a data block that is not mirrored in the first drive and the second drive.

11. An apparatus comprising:
a processor to execute instructions; and
a storage system coupled to the processor, the storage system including a first disk and a second disk, the storage system further including a controller to receive a write request to write multiple data blocks into the first disk and the second disk, and responsive to the write request to cause a write of a first block group of the multiple data blocks corresponding to even data blocks into the first disk in a first time period and a write of a second block group of the multiple data blocks corresponding to odd data blocks into the second disk in the first time period, wherein the first block group and the second block group are different groups of data.

12. The apparatus of claim 11, wherein the storage system comprises a redundant array of inexpensive or independent disks (RAID) system having a RAID 1 configuration.

13. The apparatus of claim 11, wherein the controller is to perform a second write to write the first block group into the second disk and write the second block group into the first disk, during a second time period, the second time period after the first time period, and initiated when an activity level of the first disk and second disk is below a threshold.

14. The apparatus of claim 13, wherein the controller is to perform the second write based on entries in a queue, wherein the queue is to store entries each corresponding to a data block that is not mirrored in the first drive and the second drive.

15. The apparatus of claim 11, wherein the controller is to receive a user command to cause the write of the first block group into the first disk and the second block group into the second disk during the first time period, otherwise the controller is to cause the first block group and the second block group to be written into both of the first disk and the second disk substantially simultaneously.
